(19) United States
(12) Patent Application Publication
(10) Pub. No.: US 2005/0284387 A1
(43) Pub. Date: Dec. 29, 2005

(54) Tinted lacquer pet bowl

(76) Inventor: Alan Zelinger, Monsey, NY (US)

Correspondence Address: KATTEN MUCHIN ROSENMAN LLP, 575 MADISON AVENUE, NEW YORK, NY, 10022-2585, US

(21) Appl. No.: 11/152,815

(22) Filed: Jun. 14, 2005

Related U.S. Application Data
(60) Provisional application No. 60/579,374, filed on Jun. 14, 2004.

(51) Int. Cl. A01K 5/01

(52) U.S. Cl. 119/61.5

(57) ABSTRACT

An improved pet bowl is constructed of metal such as stainless steel and partially coated with tinted lacquer. A first layer of tinted or pigmented lacquer is applied to an outer surface of the pet bowl and a second layer of tinted lacquer may be applied to the first layer. The lacquer may include a coating made from nitrocellulose (or cellulose derivatives) and plasticizers. Decorative designs may be incorporated into the lacquer layers.

### CROSS REFERENCE TO RELATED APPLICATION

This application claims the benefit of U.S. Provisional Application 60/579,374 filed on Jun. 14, 2004 and which is hereby incorporated in its entirety.

### BACKGROUND OF THE INVENTION

1. Field of the Invention

The present invention relates to pet bowls in general, and more particularly to a pet bowl having a tinted lacquer coating applied to its outer surface.

2. Discussion of the Prior Art

Stainless steel pet bowls are traditionally primarily utilitarian. They serve as a food and/or liquid receptacle, and they do not corrode or degrade under adverse environmental conditions. Some manufacturers have even stamped or embossed designs into the stainless steel to make the bowls more attractive to the consumer. Despite these features and benefits, stainless steel dog bowls have many shortcomings.

From an aesthetic viewpoint, stainless steel bowls are fairly sterile and uninteresting to the ordinary observer. While pets may not care what their bowls look like, the appearance of the bowl has an effect on a consumer purchase, particularly with respect to a pet owner with a discerning eye. Stamping and embossing is believed to have a minimal effect at the point of purchase, especially if close observation is required to comprehend the nature of the designs. From afar, however, all stainless steel pet bowls look pretty much the same.

From a utilitarian viewpoint, bare stainless steel can be easily marred or scratched. Food and/or liquid droppings also tend to spot easily and leave marks and can be unsanitary if left untreated. Food and/or water marks also require frequent cleaning, which adds an element of aggravation to the use of a plain, stainless steel pet bowl.

### SUMMARY OF THE INVENTION

In accordance with a first aspect of the invention, an improved pet bowl is constructed of metal such as stainless steel and partially coated with tinted lacquer. A first layer of tinted or pigmented lacquer is applied to an outer surface of the pet bowl and a second layer of tinted lacquer may be applied to the first layer. The lacquer may include a coating made from nitrocellulose (or cellulose derivatives) and plasticizers.

In accordance with a second aspect of the invention, a method is provided including applying a first coating of tinted lacquer to an outer surface of a metal pet bowl; and applying a second coating of tinted lacquer to the first coating. In some embodiments, decorative designs may be applied between layers.

### BRIEF DESCRIPTION OF THE DRAWINGS

FIG. 1 is a cross-sectional view of a preferred embodiment of the inventive pet bowl according to the present invention; and

FIG. 2 is a perspective view of an alternative embodiment of the inventive pet bowl according to the present invention.

FIG. 3 is a cross-sectional perspective view of yet another alternative embodiment of the inventive pet bowl according to the present invention.

### DETAILED DESCRIPTION OF THE INVENTION

Reference will now be made in detail to embodiments of the invention that are illustrated in the accompanying drawings. Wherever possible, same or similar reference numerals are used in the drawings and the description to refer to the same or like parts or steps. The drawings are in simplified form and are not to precise scale. For purposes of convenience and clarity only, directional terms, such as top, bottom, left, right, up, down, over, above, below, beneath, rear, and front may be used with respect to the drawings. These and similar directional terms should not be construed to limit the scope of the invention in any manner. The words “connect,” “couple,” and similar terms with their inflectional morphemes do not necessarily denote direct and immediate connections, but also include connections through mediate elements or devices. Furthermore, such terms as “bowl,” “pet bowl,” “food bowl,” “pet bowl dish,” and “pet food bowl” are used interchangeably. The following detailed description is of the best mode or modes of the invention presently contemplated. Such description is not intended to be understood in a limiting sense, but to be an example of the invention presented solely for illustration thereof, and by reference to which in connection with the following description and the accompanying drawings one skilled in the art may be advised of the advantages and construction of the invention.

The stainless steel pet bowl of the present invention overcomes the shortcomings of the prior art pet bowls through the application of a tinted lacquer coating. As used herein, the term “lacquer” is generally defined as any of various clear or colored synthetic coatings made by dissolving nitrocellulose or other cellulose derivatives together with plasticizers and pigments in a mixture of volatile solvents and used to impart a high gloss to a surface. However, it will be understood that other coatings may be applied as long as the same desired effect is achieved. Furthermore, while the lacquer is described as being applied to a stainless steel pet bowl, it will be understood that application to metal other than stainless steel is also contemplated. In addition, various methods of applying the lacquer are contemplated such as by painting, spraying, electrophoresis, etc.

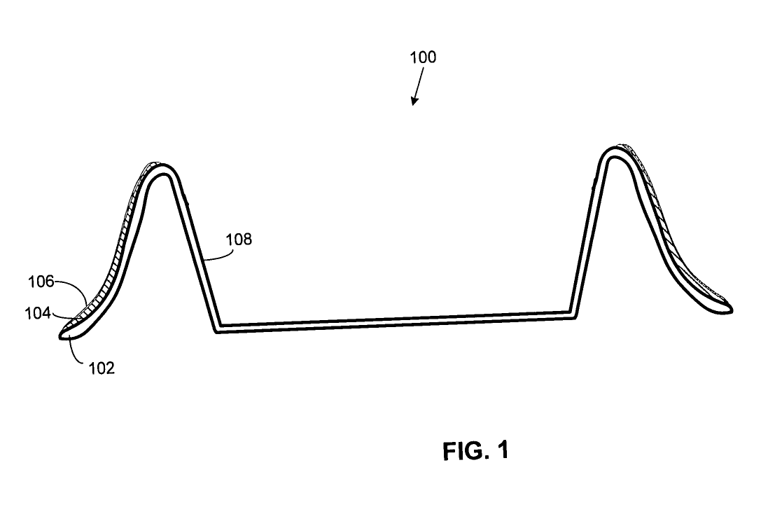

Turning to FIG. 1, a cross-section of a lacquered pet bowl 100 according to embodiments of the present invention is provided. The bowl 100 may be constructed of any metal material practicable for the purpose of providing food or water to a pet. An outer area 102 that is visible to an observer when the bowl is on the floor but not normally in contact with food or water, may be coated with a first and second coat of tinted lacquer 104, 106 (respectively). An inner surface 108 may be left bare (e.g., not coated with lacquer). In some embodiments, the inner surface 108 may be coated with one or more layers of tinted lacquer.

From an aesthetic utilitarian viewpoint, a consumer may purchase a lacquer tint finish pet bowl 100 that matches the color scheme of the location and appliances in which the pet bowl 100 will reside. Any tint color, such as red, green, yellow, blue or copper, or combinations of colors are possible, including even a fluorescent or luminescent tint that glows in the dark to address nighttime tripping hazards. Lacquering also gives the illusion of three dimensional depth through multiple applications of lacquer interspersed by multiple baking cycles in a temperature controlled oven environment, which illusion improves the overall cosmetic appearance of the pet bowl 100. A single layer of lacquer 104 may be sufficient for certain situations. The lacquering can be applied to the entire outside surface 102 of the bowl 100, or it can also be partially applied to only part of the outside 102 for variations in decorating effects as desired. It is also possible to apply pictures or logos under or in between lacquered layers 104, 106 to further decorate the pet bowl dish 100 and make it more attractive to the ultimate consumer.

From a utilitarian viewpoint, a lacquered pet bowl 100 is more hygienic than a conventional bowl because of the smooth, baked-on lacquer finish. A lacquer coating 104 protects any untreated stainless steel surface from mars and scratches, regardless of whether the stainless steel is brushed or mirror polished. This is particularly important along the outer wall 102 of a pet bowl 100 as shown in FIG. 1. The high gloss of a lacquered finish also does not show water or food spots as much as, and is much easier to clean than, un-lacquered stainless steel. In addition, the integrity of the lacquer coating will not be compromised by its cleaning in a dishwasher.

A lacquer coating 104 also creates a smoother receptive surface on which to apply stickers, decals or the like. For example, children may wish to decorate their pets' bowls with animal and/or cartoon stickers as desired, while adults may wish to apply reflective tape to the pet bowl 100 so that people do not trip over the dish at night. Stickers, decals or the like are more easily applied to and removed from a lacquer finish 104 than a brushed or mirror polished stainless steel surface.

Pet bowls 100 incorporating a tinted lacquer coating 104 may create the subtle appearance of a colored stainless steel, yet are as sturdy and reliable as traditional stainless steel bowls. The structure of the tinted lacquer may not be immediately noticeable to the naked eye, but creates a tinted, high-gloss, three-dimensional illusion as noted above. Furthermore, achieving an aesthetic benefit of a subtle colored pet bowl 100 with a tinted lacquer 104 is more beneficial than resorting to a colored plastic pet bowl that is not as structurally sound, hygienic or metallic in appearance as a stainless steel bowl.

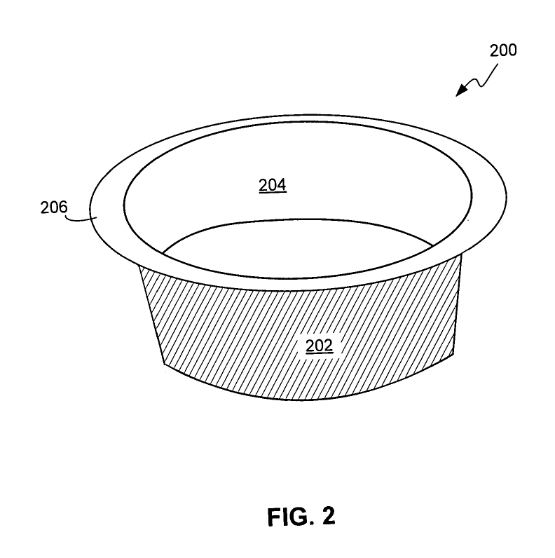

Turning to FIG. 2, a pet bowl 200 incorporating a tinted lacquer coating 202 on an outer surface and retaining a bare metal inner surface 204 according to the present invention may have a variety of shapes, sizes and configurations. For example, the coating could be applied to a conventional pudding pan profile with a rim 206, to a two-part pet bowl as shown for example in U.S. Pat. No. D466,655, to an ant-proof pet bowl as shown for example in U.S. Pat. No. D448,127, to a weighted metal pet bowl as shown for example in U.S. Pat. No. 6,112,698, to an animal feeding dish as shown for example in U.S. Pat. No. D302,753 and others. Each of the above patents are hereby incorporated herein by reference for all purposes.

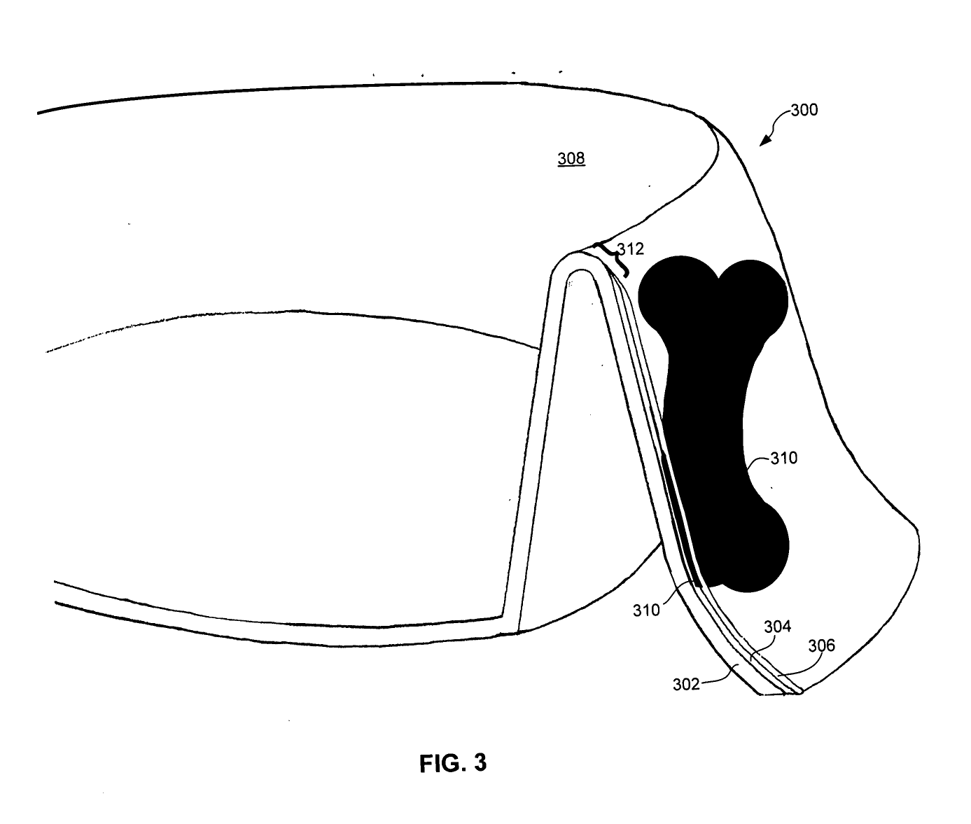

Turning to FIG. 3, an additional embodiment of the present invention is illustrated from a cross-sectional perspective view. The example pet bowl 300 is formed from a stainless steel or aluminum wall 302 and incorporates tinted lacquer coatings 304, 306 on the outer surface of the wall 302. As with the embodiments of FIGS. 1 and 2, pet bowl 300 retains a bare metal inner surface 308 but, in alternative embodiments, could be colored and/or decorated with lacquer coatings, textures, patterns, and designs. Unlike the examples pictured in FIGS. 1 and 2 however, pet bowl 300 additionally includes a decorative picture 310 layered in between the two tinted lacquer coatings 304, 306. In some embodiments, the decorative picture 310 may be below both the lacquer coatings 304, 306 and/or there may only be a single coating. The particular decorative picture 310 in the example of FIG. 3 is of a “dog bone silhouette” but any image (e.g., drawing or photograph), text characters, logo, pattern, or design may be employed. Note that at the cross-section cut-away, an edge of the decorative picture 310 is visible between the inner lacquer coating 304 and the outer lacquer coating 306.

FIG. 3 also illustrates an additional feature of the present invention. Note that at ridge area 312, (e.g., at the transition point between the lacquer coatings 304, 306 and the bare metal inner surface 308) the lacquer coatings 304, 306 are “thinned out” or “feathered” so that the lacquer has a suitable soft blend with the metal. Thus, at the ridge area 312 of the bowl 300 there are no sharp lines of lacquered/unlacquered distinction and the colored lacquer merges to the base metal in a smooth transition. In addition, the tint of the lacquer or the lacquer may be applied so that the color gradually changes as the lacquer approaches the ridge area 312 so that there is a smooth color transition from the tint color(s) to the color of the underlying metal.

In some embodiments, one or both of the tinted lacquer coatings 304, 306 may extend over the ridge area 312 to all or part of the inner surface 308. Likewise, decorative pictures may be included on the inner surface 308 (including the bottom) of the bowl 300 between or below lacquer coatings. In some embodiments, the outer lacquer coating 306 may be clear and cover both the outer surface of the wall 302 and the inner surface 308 (including the bottom) while the inner lacquer coating 304 may be tinted and only cover the outer surface of the wall 302 thinning up to the ridge area 312. Although not pictured, the lacquer coatings 304, 306 may be applied so as to thin out at the lower edge of the outer surface of the wall 302 also.

Further, while the present invention has been described at some length and with some particularity with respect to the several described embodiments, it is not intended that it should be limited to any such particulars or embodiments or any particular embodiment, but it is to be construed with references to the appended claims so as to provide the broadest possible interpretation of such claims in view of the prior art and, therefore, to effectively encompass the intended scope of the invention. Furthermore, the foregoing describes the invention in terms of embodiments foreseen by the inventor for which an enabling description was available, notwithstanding that insubstantial modifications of the invention, not presently foreseen, may nonetheless represent equivalents thereto.

1. An apparatus comprising:
a pet bowl constructed of metal and having an inner surface and an outer surface; and
a first layer of lacquer applied to the outer surface and having a tint.

2. The apparatus of claim 1 further comprising a second layer of lacquer applied to the first layer.

3. The apparatus of claim 1 wherein the metal is stainless steel.

4. The apparatus of claim 1 wherein the lacquer includes a coating made from nitrocellulose.

5. The apparatus of claim 1 wherein the lacquer includes a coating made from cellulose derivatives and plasticizers.

6. The apparatus of claim 1 wherein the lacquer is applied to the pet bowl via at least one of painting, spraying, and electrophoresis.

7. The apparatus of claim 1 wherein the inner surface remains uncoated.

8. A method comprising:
applying a first coating of tinted lacquer to an outer surface of a metal pet bowl; and
applying a second coating of tinted lacquer to the first coating.

9. The method of claim 8 wherein the metal comprises stainless steel.

10. The method of claim 8 wherein the lacquer includes a coating made from nitrocellulose.

11. The method of claim 8 wherein the lacquer includes a coating made from cellulose derivatives and plasticizers.

12. The method of claim 8 wherein the steps of applying lacquer include at least one of painting, spraying, and electrophoresis.

13. The method of claim 8 further comprising a step of masking an inner surface of the pet bowl before applying the first coating.

14. The method of claim 8 further comprising heating the pet bowl after applying the first coating.

15. The method of claim 8 further comprising applying a decorative design between the first and second layers.

16. The method of claim 8 wherein the first layer includes a tint different than a tint of the second layer.

17. The method of claim 8 wherein the first and second layers are applied to only a portion of the outer surface.

18. An apparatus comprising:
a pet bowl constructed of metal and having an inner surface and an outer surface;
a first layer of lacquer applied to the outer surface and having a tint; and
a second layer of lacquer applied to the first layer,
wherein the metal is stainless steel, and
wherein the lacquer includes a coating made from nitrocellulose and plasticizers.

19. The apparatus of claim 18 wherein the lacquer is applied to the pet bowl via at least one of painting, spraying, and electrophoresis.

20. The apparatus of claim 18 wherein the inner surface remains uncoated.

21. The apparatus of claim 20 wherein a transition between the layers of lacquer and the inner surface is gradual so that the transition is smooth.

22. The apparatus of claim 21 wherein the transition includes a gradual color change from a color of the tint to a color of the metal.

23. The apparatus of claim 18 wherein a design is disposed between the first and second layer of lacquer.
